(19) United States
(12) Patent Application Publication
(10) Pub. No.: US 2023/0027768 A1
(43) Pub. Date: Jan. 26, 2023

(54) NEURAL NETWORK COMPUTING DEVICE AND COMPUTING METHOD THEREOF

(71) Applicant: UPBEAT TECHNOLOGY Co., Ltd, New Taipei City (TW)

(72) Inventors: Chung-Chieh CHEN, New Taipei City (TW); Da-Ming CHIANG, New Taipei City (TW); Shuo-Hong HUNG, New Taipei City (TW)

(21) Appl. No.: 17/871,539

(22) Filed: Jul. 22, 2022

Related U.S. Application Data
(60) Provisional application No. 63/224,924, filed on Jul. 23, 2021.

(51) Int. Cl. G10L 19/04; G06F 7/544; G06F 17/16

(52) U.S. Cl. CPC G10L 19/04; G06F 7/5443; G06F 17/16

(57) ABSTRACT

A computing method for performing a matrix multiplying-and-accumulating computation by a flash memory array which includes word lines, bit lines and flash memory cells. The computing method includes the following steps: respectively storing a weight value in each of the flash memory cells, receiving a plurality of input voltages via the word lines, performing an computation on one of the input voltages and the weight value by each of the flash memory cells to obtain an output current, outputting the output currents of the flash memory cells via the bit lines, and accumulating the output currents of the flash memory cells connected to the same bit line of the bit lines to obtain a total output current. Each of the flash memory cells is an analog device, and each of the input voltages, each of the output currents and each of the weight values are analog values.

This application claims the benefit of U.S. provisional application Ser. No. 63/224,924, filed Jul. 23, 2021, the subject matter of which is incorporated herein by reference.

### TECHNICAL FIELD

The present disclosure relates to a computing device and a computing method thereof, and more particularly, to a memory device for performing matrix multiplication and a computing method thereof.

### BACKGROUND

With the rapid progress of technology, artificial intelligence (Al) has been widely used at all aspects. Algorithms of Al often involve complex computations on big data, such as, Al may simulate neural network behavior models and perform core computations on big data.

However, this type of core computation usually requires an independent computing processor, and needs to repeatedly perform multiplying-and-accumulating computations, and cooperate with a memory to access the computation data. The input data of the core computation and the corresponding computation result need to be transferred back and forth between the core computing processor and the memory. Based on the above characteristics, the core computation of Al often consumes a huge amount of computing resources, which leads to a great increase in the overall computing cycle. Moreover, the round-trip transmission of a huge amount of input data and computing results also leads to congestions in interfaces between the core computing processor and the data storage unit.

In view of the above-mentioned technical problems, skilled ones in related industries of this technical field are devoted to develop improved computing devices and computing methods, so as to more efficiently execute the core computation of AI simulated neural network models.

### SUMMARY

The present disclosure provides a technical solution, which utilizes a memory device to perform a matrix multiplying-and-accumulating computation with an analog signal. Each flash memory cell of the memory device may store the weight value of the matrix multiplication respectively, and may adjust the weight value of the flash memory cell by adjusting the threshold voltage of the transistor of the flash memory cell. The analog memory device may have a higher storage density, and since the multiplication and accumulation may be performed directly inside the memory (i.e.: in-memory computing (IMC)), no need to read data in batches from external memory, so that a smaller circuit structure and higher computing efficiency are achieved. Accordingly, the technical solution of the present disclosure may execute the core computation of the neural network model with low area and low power consumption.

According to an aspect of the present disclosure, a computing device is provided. The computing device includes a flash memory array for performing a matrix multiplying-and-accumulating computation, the flash memory array includes a plurality of word lines, a plurality of bit lines and a plurality of flash memory cells. The flash memory cells are arranged in an array and respectively connected to the word lines and the bit lines, for receiving a plurality of input voltages via the word lines and outputting a plurality of output currents via the bit lines, and the output currents of the flash memory cells connected to the same bit line of the bit lines are accumulated to obtain a total output current. Furthermore, each of the flash memory cells stores a weight value respectively, and each of the flash memory cells is operated with one of the input voltages and the weight value to obtain one of the output currents, each of the flash memory cells is an analog element, and each of the input voltages, each of the output currents and each of the weight values is an analog value.

According to another aspect of the present disclosure, a computing method for performing a matrix multiplying-and-accumulating computation by a flash memory array which includes word lines, bit lines and flash memory cells, is provided. The computing method includes the following steps: respectively storing a weight value in each of the flash memory cells, receiving a plurality of input voltages via the word lines, performing an computation on one of the input voltages and the weight value by each of the flash memory cells to obtain an output current, outputting the output currents of the flash memory cells via the bit lines, and accumulating the output currents of the flash memory cells connected to the same bit line of the bit lines to obtain a total output current. Each of the flash memory cells is an analog device, and each of the input voltages, each of the output currents and each of the weight values are analog values.

### BRIEF DESCRIPTION OF THE DRAWINGS

FIG. 1 is a block diagram of a computing system according to an embodiment of the present disclosure.

FIG. 2 is a block diagram of a computing device according to an embodiment of the present disclosure.

FIG. 3 is a schematic diagram of a matrix multiplier according to an embodiment of the present disclosure.

FIG. 4 is a schematic diagram of a memory device for performing matrix multiplication according to an embodiment of the disclosure.

FIG. 5A is a circuit diagram of the flash memory cells of the memory device of FIG. 4.

FIG. 5B is a schematic diagram of the computation of the flash memory cells of FIG. 5A.

FIG. 6A is a cross-sectional view of the transistor of FIG. 5A.

FIG. 6B is a timing diagram of the programming voltage applied to the transistor of FIG. 6A.

FIG. 6C is a diagram of current-voltage graph the transistor of FIG. 6A.

FIG. 7 is a schematic diagram of a memory device for performing matrix multiplication according to another embodiment.

FIGS. 8A and 8B are flowcharts of a computing method of an embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawing.

### DETAILED DESCRIPTION

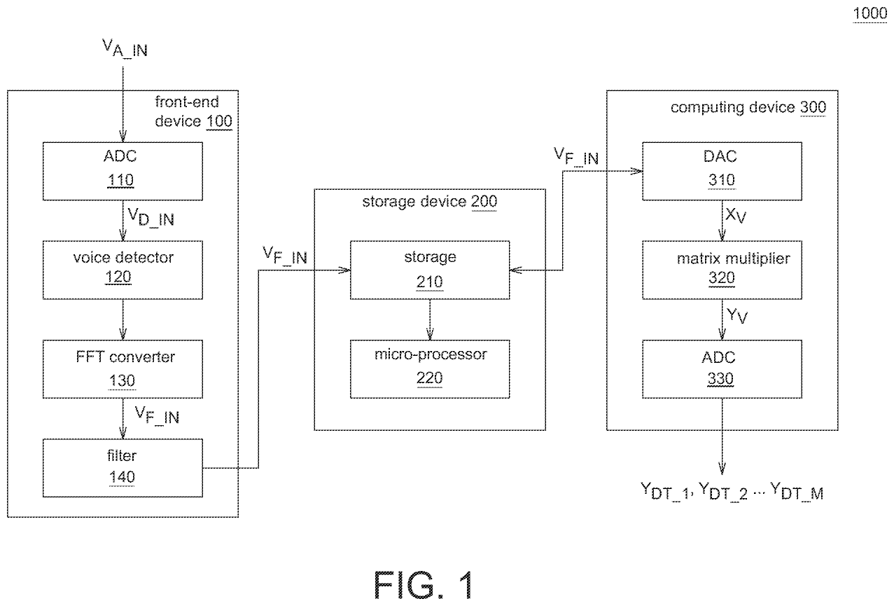

FIG. 1 is a block diagram of a computing system 1000 according to an embodiment of the present disclosure. Referring to FIG. 1, the computing system 1000 includes a front-end device 100, a storage device 200 and a computing device 300.

The front-end device 100 includes an analog-to-digital converter (ADC) 110, a voice detector (VAD) 120, a fast Fourier-transform (FFT) converter 130 and a filter 140. The front-end device 100 receives an analog voice input signal V_{A_IN}, and converts the analog voice input signal V_{A_IN} to a digital voice input signal V_{D_IN} via the ADC 110. Then, the voice detector 120 detects the amplitude of the digital voice input signal V_{D_IN}, and if the amplitude of the digital voice input signal V_{D_IN} is less than a threshold, the digital voice input signal V_{D_IN} will not be processed subsequently. If the amplitude of the digital voice input signal V_{D_IN} exceeds a threshold, the subsequent FFT converter 130 converts the digital voice input signal V_{D_IN} into an input signal V_{F_IN}. Then, the noise and unnecessary harmonics of the input signal V_{F_IN} are filtered out via the filter 140.

The noise-filtered input signal V_{F_IN} may be sent to the storage device 200 for processing. The storage device 200 includes a storage 210 and a micro-processor 220. The storage 210 is, for example, a static random access memory (SRAM) to temporarily store the input signal V_{F_IN}. In addition, the micro-processor 220 is, for example, a reduced instruction set processor (RISC), which may perform auxiliary computations on the input signal V_{F_IN}.

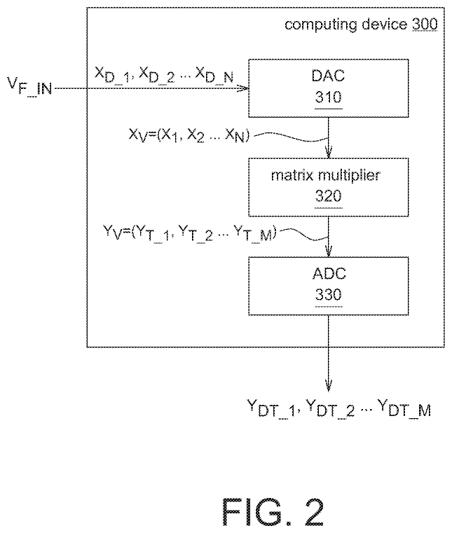

The computing device 300 may read the input signal from the storage 210 of the storage device 200 to perform core computations. Please also refer to FIG. 2, which shows a block diagram of a computing device 300 according to an embodiment of the present disclosure. The computing device 300 includes a matrix multiplier 320 and an analog-to-digital converter (ADC) 330. When the computing device 300 outputs the digital signal, the computing device 300 may selectively include a digital-to-analog converter (DAC) 310. The input signal V_{F_IN}, which is read by the computing device 300 from the storage device 210 of the storage device 200, includes digital input signals X_{D_1}, X_{D_2}, . . . , X_{D_N}, which may be converted into digital input voltages X₁, X₂, . . . , X_{N} with analog values by DAC 310.

The computing device 300 may perform core computations on the input voltages X₁, X₂, . . . , X_{N}, for example, perform a Convolutional Neural Network (CNN) computation. The matrix multiplier 320 of the computing device 300 may perform multiplication and accumulation on the input voltages X₁, X₂, . . . , X_{N} to obtain the total output currents Y_{T_1}, Y_{T_2}, . . . , Y_{T_M}. The input voltages X₁, X₂, . . . , X_{N} may form an input vector Xᵥ, and the total output currents Y_{T_1}, Y_{T_2}, . . . , Y_{T_M} may form a output vector Yᵥ. Both the input vector Xᵥ and the output vector Yᵥ are analog values, and the matrix multiplier 320 is an analog computing engine (ACE) to perform analog multiplication and accumulation. In addition, the matrix multiplier 320 itself is also a storage element, which may store the weight values G₁₁˜G_{NM} of the multiplication. Then, the ADC 330 may convert the total output currents Y_{T_1}, Y_{T_2}, . . . , Y_{T_M} (forming the output vector Yᵥ) into digital output signals Y_{DT_1}, Y_{DT_1}, . . . , Y_{DT_M}.

In this embodiment, the matrix multiplier 320 may, for example, perform a convolution computation, which involves a large amount of multiplication and accumulation and a large amount of input/output data. In order to rapidly perform multiplication and accumulation and save data transmission between the matrix multiplier 320 and other processing units (e.g., the storage device 200), the matrix multiplier 320 may use an in-memory computing (IMC) to perform a matrix multiplication as described below.

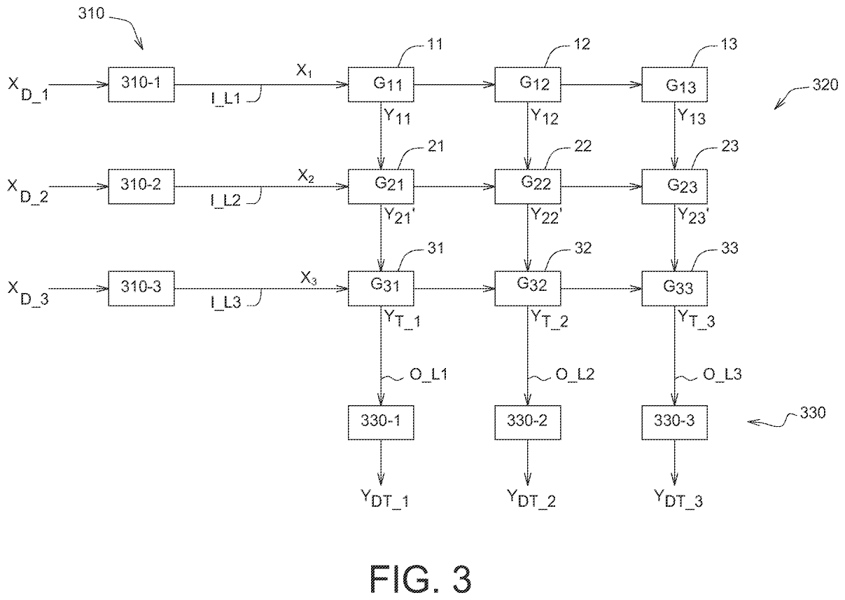

FIG. 3 is a schematic diagram of a matrix multiplier 320 according to an embodiment of the present disclosure. Referring to FIG. 3, the matrix multiplier 320 in this embodiment performs a matrix multiplication with a dimension of 3×3, as an example. The matrix multiplier 320 includes, for example, nine multiplier units 11˜33. The multiplier units 11, 12 and 13 are disposed at the first column address and connected to the first input line I_L1, and receive the first input voltage X₁ via the first input line I_L1. Similarly, the multiplier units 21, 22 and 23 are arranged at the second column address and connected to the second input line I_L2, and receive the second input voltage X₂ via the second input line I_L2. In addition, the multiplier units 31, 32 and 33 are arranged at the third column address and connected to the third input line I_L3, and receive the third input voltage X₃ via the third input line I_L3. For the input terminal of the matrix multiplier 320, the matrix multiplier 320 may be connected to the DAC 310-1, 310-2 and 310-3 in the DAC unit 310. The digital input signal X_{D_1} may be converted into the first input voltage X₁ of the analog value by the DAC 310-1. Similarly, the digital input signals X_{D_2}, X_{D_3} may be converted to the second and third input voltages X₂ and X₃ of analog values by the DAC 310-2 and 310-3. In addition, the first, second and third input voltages X₁, X₂ and X₃ may form an input vector Xᵥ.

On the other hand, the multiplier units 11, 21, and 31 are disposed at the first row address and connected to the first output line O_L1, and output the first total output current Y_{T_1} via the first output line O_L1. Similarly, the multiplier units 12, 22 and 32 are disposed at the second row address and connected to the second output line O_L2, and output the second total output current Y_{T_2} via the second output line O_L2. In addition, the multiplier units 13, 23 and 33 are disposed at the third row address and connected to the third output line O_L3, and output the third total output current Y_{T_3} via the third output line O_L3. For the output terminal of the matrix multiplier 320, the matrix multiplier 320 may be connected to the ADC 330-1, 330-2 and 330-3 in the ADC unit 330. The first total output current Y_{T_1} of analog value may be converted into a digital output signal Y_{DT_1} by the ADC 330-1. Similarly, the second and third total output currents Y_{T_2} and Y_{T_3} of analog value may be converted into digital output signals Y_{DT_2} and Y_{DT_3} by the ADC 330-2 and 330-3. Moreover, the total output currents Y_{T_1}, Y_{T_2}, Y_{T_3} may form an output vector Yᵥ.

Each of the multiplier units 11˜33 may perform a multiplication. Taking the multiplier unit 11 disposed at the address of first column and first row as an example, the multiplier unit 11 may store a weight value G₁₁, and perform a multiplication on the input value X₁ and the weight value G₁₁ to obtain an output current Y₁₁, and the output current Y₁₁ may be outputted via the first output line O_L1. The output current Y₁₁ of the multiplier unit 11 is shown in formula (1):

Y₁₁=X₁×G₁₁ (1)

Similarly, the multiplier unit 21 disposed at the address of second column and second row may store the weight value G₂₁ and perform a multiplication on the input value X₂ and the weight value G₂₁ to obtain an output current Y₂₁. The output current Y₂₁ of the multiplier unit 21 is shown in formula (2):

Y₂₁=X₂×G₂₁ (2)

Since the multiplier units 11 and 21 are both connected to the first output line O_L1, the output current Y₁₁ of the multiplier unit 11 and the output current Y₂₁ of the multiplier unit 21 may be summed as the total output current Y₂₁′ via the output line O_L1. (i.e., the output current Y₂₁ is the temporary computation result of the multiplier unit 21, and the output current Y₂₁ and the output current Y₁₁ are immediately summed as the total output current Y₂₁′, hence only the total output current Y₂₁′ is shown on the output line O_L1 in FIG. 3, and the output current Y₂₁ is not shown.

In addition, the multiplier unit 31 disposed at the address of third column and first row may store the weight value G₃₁, and perform a multiplication on the input voltage X₃ and the weight value G₃₁ to obtain the output current Y₃₁. The output current Y₃₁ of the multiplier unit 31 is shown in formula (3):

Y₃₁=X₃×G₃₁ (3)

In addition, the output current Y₃₁ of the multiplier unit 31 and the total output current Y₂₁′ may be summed up again via the output line O_L1 to obtain the total output current Y_{T_1}. (i.e., the output current Y₃₁ is the temporary computation result of the multiplier unit 31, the output current Y₃₁ is immediately summed with the total output current Y₂₁′ to form the total output current Y_{T_1}, hence only the total output current Y_{T_1} is shown on the output line O_L1 in FIG. 3, and the output current Y₃₁ is not shown). The total output current Y_{T_1} of the first output line O_L1 is shown in equation (4):

$${Y}_{T \_ 1} = {\sum }_{i = 1 \sim 3} ( {X}_{i 1} ⨯ {G}_{i 1} ) = [ {X}_{1} , {X}_{2} , {X}_{3} ] ⨯ [ \begin{matrix}{G}_{11} \\ {G}_{21} \\ {G}_{31}\end{matrix} ] \qquad ( 4 )$$

Based on the same computing method, the multiplier units 12, 22 and 32 disposed at the address of second row may store the weight values G₁₂, G₂₂ and G₃₂, respectively. Multiplications are performed on the input voltages X₁, X₂, X₃ and the weight values G₁₂, G₂₂, G₃₂ to obtain corresponding output currents Y₁₂, Y₂₂ and Y₃₂. In addition, the total output current Y_{T_2} is obtained by accumulating the output currents Y₁₂, Y₂₂ and Y₃₂ via the second output line O_L2. The total output current Y_{T_2} of the second output line O_L2 is shown in equation (5):

$${Y}_{T \_ 2} = {\sum }_{i = 1 \sim 3} ( {X}_{i 2} ⨯ {G}_{i 2} ) = [ {X}_{1} , {X}_{2} , {X}_{3} ] ⨯ [ \begin{matrix}{G}_{12} \\ {G}_{22} \\ {G}_{33}\end{matrix} ] \qquad ( 5 )$$

Similarly, the multiplier units 13, 23 and 33 disposed at the address of third row may store the weight values G₁₃, G₂₃ and G₃₃, respectively. Multiplications are performed on the input voltages X₁, X₂, X₃ and the weight values G₁₃, G₂₃ and G₃₃, respectively, to obtain corresponding output currents Y₁₃, Y₂₃ and Y₃₃. In addition, the total output current Y_{T_3} is obtained by accumulating the output currents Y₁₃, Y₂₃ and Y₃₃ via the third output line O_L3. The total output current Y_{T_3} of the third output line O_L3 is shown in equation (6):

$${Y}_{T \_ 3} = {\sum }_{i = 1 \sim 3} ( {X}_{i 3} ⨯ {G}_{i 3} ) = [ {X}_{1} , {X}_{2} , {X}_{3} ] ⨯ [ \begin{matrix}{G}_{13} \\ {G}_{23} \\ {G}_{33}\end{matrix} ] \qquad ( 6 )$$

From the above, the weight values G₁₁ to G₃₃ stored in each of the multiplier units 11 to 33 may form a weight matrix G_{M}, as shown in equation (7):

$${G}_{M} = [ \begin{matrix}{G}_{11} & {G}_{12} & {G}_{13} \\ {G}_{21} & {G}_{22} & {G}_{23} \\ {G}_{31} & {G}_{32} & {G}_{33}\end{matrix} ] \qquad ( 7 )$$

The matrix multiplier 320 of this embodiment may multiply the input vector Xᵥ composed of the first to third input voltages X₁ to X₃ by the weight matrix G_{M} to obtain the output vector Yᵥ. In other words, the output vector Yᵥ is the matrix product of the input vector Xᵥ and the weight matrix G_{M}.

The output vector Yᵥ is composed of the first to third total output currents Y_{T_1} to Y_{T_3}, as shown in equation (8):

Y_{V}=[Y_{T_1},Y_{T_2},Y_{T_3}]=X_{V}×G_{M} (8)

The matrix multiplier 320 described above may be implemented by an analog memory device, as described in detail below.

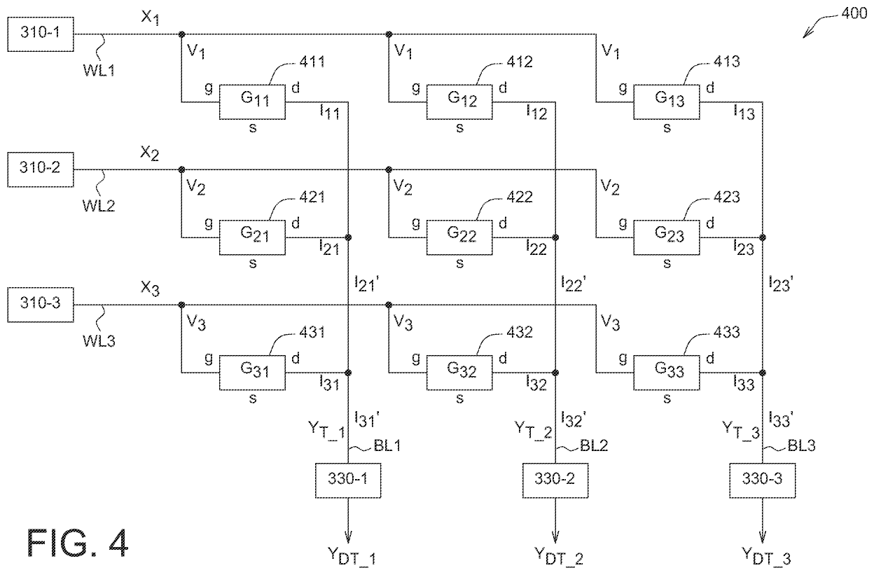

FIG. 4 is a schematic diagram of a memory device 400 for performing matrix multiplication according to an embodiment of the disclosure. Referring to FIG. 4, the memory device 400 of the present embodiment may be used to implement the matrix multiplier 320 of FIG. 3 to perform a 3×3 dimensional matrix multiplication. The flash memory array of the memory device 400 includes, for example, nine flash memory cells 411-433, these flash memory cells 411-433 may respectively correspond to the multiplier units 11-33 in FIG. 3 to perform multiplications.

The flash memory array of the memory device 400 of the present embodiment has word-lines WL1, WL2 and WL3, which correspond to the input lines I_L1, I_L2 and I_L3 of the matrix multiplier 320 in FIG. 3, respectively. The flash memory array of the memory device 400 has bit-lines BL1, BL2 and BL3, which correspond to the output lines O_L1, O_L2 and O_L3 of the matrix multiplier 320 in FIG. 3, respectively. Each of the flash memory cells 411-433 of the flash memory array of the memory device 400 comprises a transistor, and the gate “g” of each these transistors may be connected to a corresponding one of the word lines WL1, WL2 and WL3, and the drain “d” of each of these transistors may be connected to a corresponding one of the bit lines BL1, BL2 and BL3. In addition, the source “s” of each of these transistors may be connected to a source line switch circuit (not shown) via a plurality of source lines (not shown). Source line switching circuits may select the transistors via the source lines.

In computation, the gates “g” of these transistors may receive gate voltages V1, V2 and V3 via corresponding input lines I_L1, I_L2 and I_L3, respectively. The voltage values of the gate voltages V1, V2 and V3 correspond to the input voltages X1, X2 and X3, respectively. On the other hand, the drains “d” of these transistors may output the drain currents via the corresponding output lines O_L1, O_L2 and O_L3, respectively. For the flash memory cells 411, 421 and 431 at the first row address, the drain “d” of the transistor of the flash memory cell 411 may output the drain current I₁₁ (corresponding to the output current Y₁₁). The drain “d” of the transistor of the flash memory cell 421 may output the drain current I₂₁ (corresponding to the output current Y₂₁), the drain current I₂₁ and the drain current I₁₁ may be summed to form the total drain current I₂₁′. The drain “d” of the transistor of the flash memory cell 431 may output the drain current I₃₁ (corresponding to the output current Y₃₁), and the drain current I₃₁ and the total drain current I₂₁′ are summed to form the total drain current I₃₁′. The current value of the total drain current I₃₁′ corresponds to the total output current Y_{T_1} of the first output line O_L1.

Based on the same computing method, for the flash memory cells 412, 422 and 432 disposed at the second row address, the drain “d” of the respective transistors of the flash memory cells 412, 422 and 432 may output drain currents I₁₂, I₂₂ and I₃₂ respectively, and the drain currents I₁₂, I₂₂ and I₃₂ may be accumulated as a total drain current I₃₂′ via the second output line O_L2. The current value of the total drain current I₃₂′ corresponds to the total output current Y_{T_2} of the second output line O_L2. Similarly, the drain “d” of the respective transistors of the flash memory cells 413, 423 and 433 disposed at the third row address may output the drain currents I₁₃, I₂₃ and I₃₃, respectively. The drain currents I₁₃, I₂₃, and I₃₃ may be outputted respectively by the drain “d” of transistors via the output line O_L3. The currents I₁₃, I₂₃ and I₃₃ are accumulated to form the total drain current I₃₃′. The current value of the total drain current I₃₃′ corresponds to the total output current Y_{T_3} of the output line O_L3.

From the above, each of the flash memory cells 411˜433 may respectively generate corresponding drain currents I₁₁˜I₃₃ in response to the gate voltages V1, V2 and V3 received by the transistors. The generated drain currents I₁₁˜I₃₃ are the products of the gate voltages V1, V2 and V3 and the equivalent conductance values of the transistors of the flash memory cells 411˜433. The equivalent conductance values of the transistors of the memory cells 411˜433 are the weight values G₁₁ to G₃₃ corresponding to the multipliers. Accordingly, the flash memory cells 411˜433 may perform multiplications.

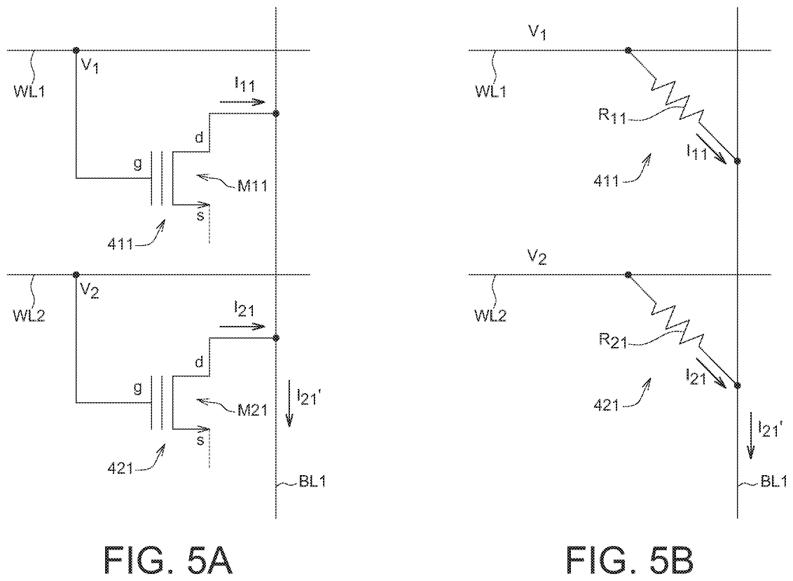

FIG. 5A is a circuit diagram of the flash memory cells 411 and 421 of the memory device 400 of FIG. 4. Referring to FIG. 5A, the gate “g” of the transistor M11 of the flash memory cell 411 receives the gate voltage V₁ from the word line WL1. In response to the voltage value of the gate voltage V₁, the transistor M11 generates a drain current I₁₁ correspondingly, and outputs the drain current I₁₁ to the bit line BL1 via the drain “d” of the transistor M11. If the transistor M11 of the flash memory cell 411 operates in the triode region, the relationship between the gate voltage V₁ of the transistor M11 and the drain current I₁₁ is as shown in equation (9):

$${I}_{11} = {μ}_{n} {C}_{ox} [ ( {V}_{1} - {V}_{t} ) {V}_{d} - \frac{1}{2} {V}_{d}^{2} ] \qquad ( 9 )$$

Wherein, V_{d} is the drain voltage of the transistor M11, and Vₜ is the threshold voltage of the transistor M11, and it is assumed that the voltage value of the source voltage of the transistor M11 is the reference potential OV. In addition, μn, Cox, W and L are the device parameters such as the mobility of the transistor M11, the equivalent capacitance of the oxide dielectric layer and the width and length of the channel, respectively. According to the current-voltage relationship of formula (9), the equivalent conductance value of transistor M11 (i.e., the weight value G₁₁ of the multiplier) may be further derived, as shown in formula (10):

$${G}_{11} = {μ}_{n} {C}_{o x} \frac{W}{L} ( {V}_{1} - {V}_{t} ) \qquad ( 10 )$$

Similarly, the gate “g” of the transistor M21 of another flash memory cell 421 connected to the same bit line BL1 as the flash memory cell 411 receives another gate voltage V2 from the second word line WL2 and a drain current I21 is generated, and the drain current I₂₁ is outputted to the bit line BL1 via the drain “d” of the transistor M21. The drain current I₂₁ of the transistor M21 and the drain current I₁₁ of the transistor M11 are summed to form the total drain current I₂₁′. The relationship between the gate voltage V2 of the transistor M21 of the flash memory cell 421 and the drain current I21 is shown in equation (11), and the equivalent conductance value of the transistor M21 (i.e.. the weight value G₂₁ of the multiplier) is shown in the equation (12) shown:

$${I}_{21} = {μ}_{n} {C}_{o x} \frac{W}{L} [ ( {V}_{2} - {V}_{t} ) {V}_{d} - \frac{1}{2} {V}_{d}^{2} ] \qquad ( 11 )$$

$${G}_{21} = {μ}_{n} {C}_{o x} \frac{W}{L} ( {V}_{2} - {V}_{t} ) \qquad ( 12 )$$

If the transistors M11 and M21 are floating gate transistors, the threshold voltage Vt of the transistors M11 and M21 may be adjusted and changed. According to equations (10) and (12), the equivalent conductance values G₁₁ and G₂₁ of the transistors M11 and M21 may be changed by adjusting the threshold voltage Vt of the transistors M11 and M21. In other words, the weight values G₁₁ and G₃₃ of the matrix multiplication performed by the memory device 400 may be changed by adjusting the threshold voltages Vt of the transistors M11 and M21.

FIG. 5B is a schematic diagram of the computation of the flash memory cells 411 and 421 of FIG. 5A. Referring to FIG. 5B, the transistor M11 of the flash memory cell 411 may form a resistor R₁₁ and is connected to the word line WL1 and the bit line BL1, and the gate voltage V1 received by the word line WL1 is applied to the resistor R₁₁ and drain current I₁₁ is generated. The resistance value of the resistor R₁₁ is the reciprocal of the equivalent conductance value G₁₁. Similarly, the transistor M21 of the adjacent flash memory cells 421 connected to the same bit line BL1 may form a resistor R₂₁ and connected to the word line WL2 and the bit line BL1. The gate voltage V₂ received by the word line WL2 is applied to the resistor R₂₁ to generate the drain current I₂₁, and the drain current I₂₁ and the drain current I₁₁ of the flash memory cell 411 are summed to form the total drain current I₂₁′. The resistance value of the resistor R₂₁ formed by the transistor M21 of the flash memory cell 421 is the reciprocal of the equivalent conductance value G₂₁.

If the transistors M11 and M21 of the flash memory cells 411 and 421 are floating gate transistors, the threshold voltage Vt of the transistors M11 and M21 may be adjusted and changed; the threshold voltage Vt of the transistors M11 and M21 may be adjusted by adjusting the threshold voltage Vt of the transistors M11 and M21 to change the resistance value of the resistance R₁₁ and R₂₁. In other words, the resistors R₁₁ and R₂₁ formed by the transistors M11 and M21 are variable resistors.

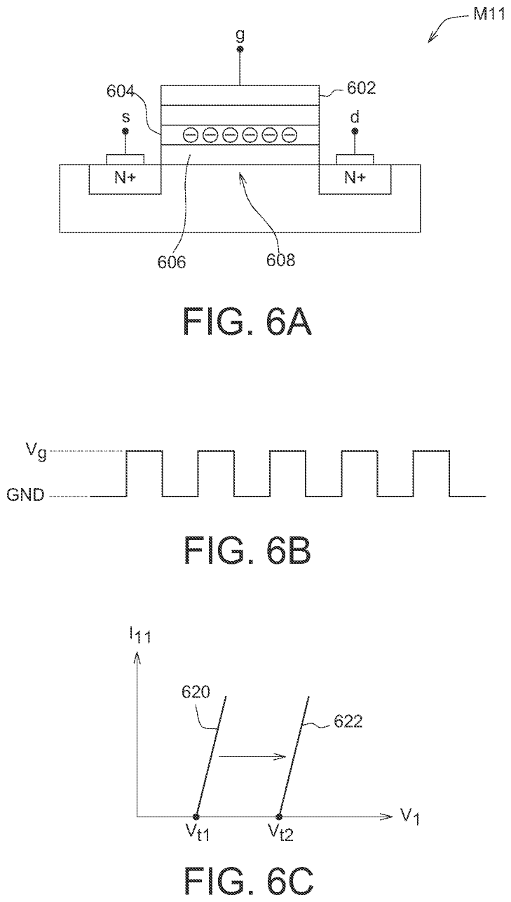

FIG. 6A is a cross-sectional view of the transistor M11 of FIG. 5A, FIG. 6B is a timing diagram of the programming voltage V_{g} applied to the transistor M11 of FIG. 6A, and FIG. 6C is a diagram of current-voltage graph the transistor M11 of FIG. 6A. Referring to FIG. 6A, the transistor M11 is a floating gate transistor, and a floating gate 604 is provided under a control gate 602 of the transistor M11. In addition, an oxide layer 606 is disposed under the floating gate 604, and a channel region 608 of the transistor M11 is formed under the oxide layer 606 and between the two N-type doped regions. Also referring to FIG. 6B, the programming voltage V_{g} may be applied to the gate “g” of the transistor M11. If the programming voltage V_{g} is a positive voltage with a higher voltage value (much higher than the reference potential GND=OV), the hot electrons is attracted from the channel region 608 to the floating gate 604, i.e., a charge trapping operation. If the floating gate 604 captures more trapped charges (i.e., negative charges), the transistor M11 has a higher threshold voltage.

Referring also to FIG. 6C, before the application of the programming voltage V_{g}, the current-voltage relationship of the transistor M11 may be represented as a current-voltage curve (i.e., I-V curve) 620. According to the current-voltage curve 620, the threshold voltage of the transistor M11 is Vₜ₁. After the programming voltage V_{g} is applied, the floating gate 604 captures more trapped charges and raises the threshold voltage to Vₜ₂. At this time, the transistor M11 has a current-voltage curve 622. Accordingly, the threshold voltage of the transistor M11 may be changed to Vt by the programming voltage V_{g}, and then the equivalent conductance value G₁₁ of the transistor M11 may be changed, so that the multiplication corresponding to the transistor M11 has different weight values.

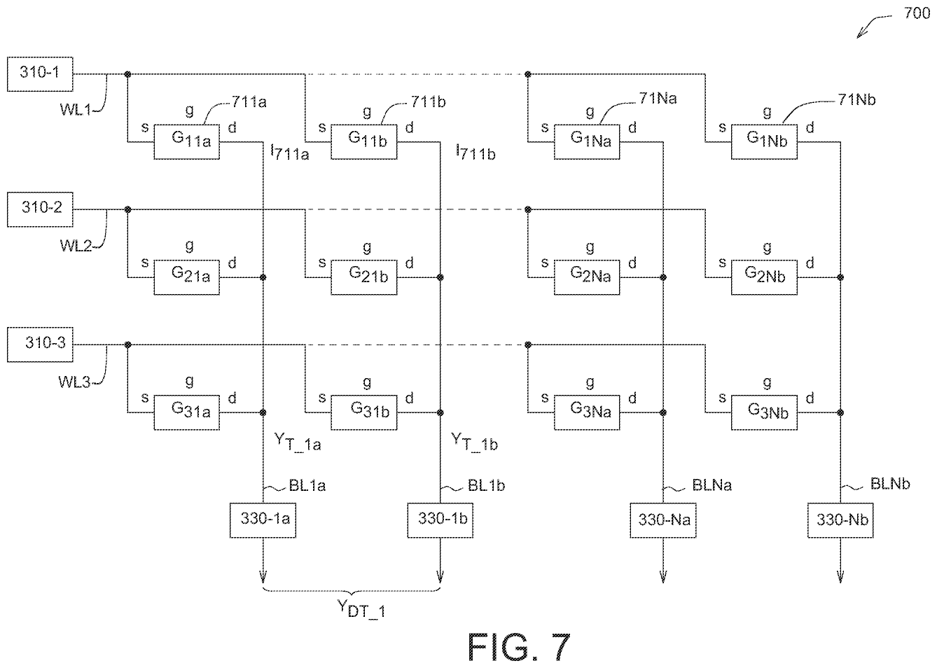

The above is an embodiment in which the transistor of the flash memory cell is used as an example of a floating gate transistor, and the threshold voltage of the transistor may be adjusted to set different weight values of the multiplication. The following describes another implementation. FIG. 7 is a schematic diagram of a memory device 700 for performing matrix multiplication according to another embodiment. Referring to FIG. 7, the flash memory array of the memory device 700 of this embodiment has word lines WL1, WL2 and WL3, which correspond to the input lines I_L1, I_L2 and I_L3 of the matrix multiplier 320 in FIG. 3, respectively. The flash memory array of the memory device 700 has bit-lines BL1a, BL1b, . . . , BLNa, BLNb, which correspond to the output lines O_L1, O_L2 and O_L3 of the matrix multiplier 320 in FIG. 3. Each of the flash memory cells 711a, 711b, . . . , 711Na, 711Nb includes a transistor, sources “s” of the transistors are connected to corresponding word lines WL1, WL2 and WL3, and drains “d” of these transistors are connected to corresponding bit lines BL1a, BL1b, . . . , BLNa, BLNb. In addition, gates “g” of these transistors are connected to a gate line switch circuit (not shown) via a plurality of gate lines (not shown). The gate line switch circuit may select the transistors via the gate lines.

Please refer to the memory device 400 of FIG. 4 again, the transistors of each of the flash memory cells 411-433 are floating gate transistors, so the threshold voltage Vₜ of the transistors is adjustable such that each of the flash memory cells 411 to 433 may store a weight value of a multi-level value, wherein the weight value of the multi-level value has at least 4 levels. For example, when the weight value has 4 levels, the weight value is a 2-bit digital value. When the weight value has 8 levels, the weight value is a 3-bit digital value. When the weight value has 16 levels, the weight value is a 4-bit digital value, and so on. The weight value of the multi-level value is converted into an equivalent conductance value G, and the equivalent conductance value G is written and stored in the flash memory cells 411˜433. Therefore, the weight value of each multi-level value only needs to be stored in a single flash memory cell, and there is no need to store the weight value of the multi-level value in many flash memory cells, which may greatly reduce the cost. Taking the flash memory cell 411 as an example, a single flash memory cell 411 may store the weight value G₁₁ of the multi-level value, so the current value of the drain current I₁₁ generated by the flash memory cell 411 is also the multi-level value. Accordingly, the total output current Y_{T_1} may be converted by the ADC 330-1 to obtain a digital output signal Y_{DT_1} with a multi-level value, and the digital output signal Y_{DT_1} may have multiple bits.

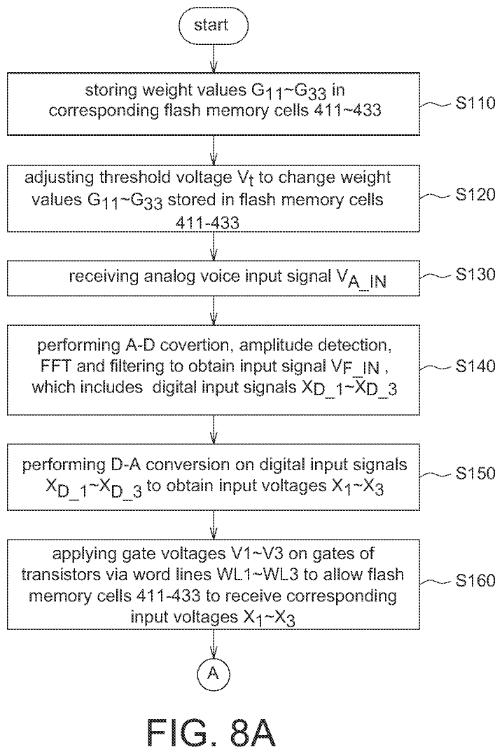

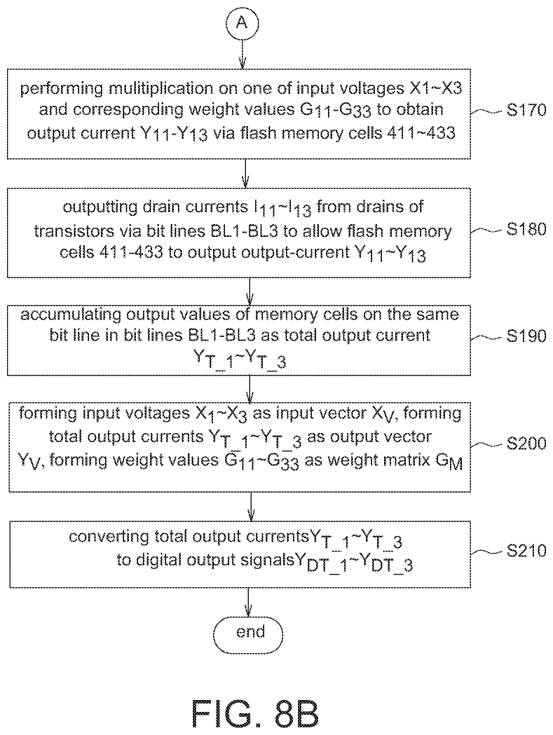

FIGS. 8A and 8B are flowcharts of a computing method of an embodiment of the present disclosure. The computing method of this embodiment may be implemented with the computing system 1000 in FIG. 1, the computing device 300 in FIG. 2, the matrix multiplier 320 in FIG. 3 and the memory device 400 in FIG. 4. Please refer to FIG. 8A, in step S110, the weight values G₁₁˜G₃₃ are respectively stored in the corresponding flash memory cells 411˜433. More specifically, the memory device 400 is an analog device, so the flash memory cells 411˜433 may respectively store weight values G₁₁˜G₃₃ of the analog values, and these weight values G₁₁˜G₃₃ are the weight values of matrix multiplication. Since the weight values G₁₁˜G₃₃ of the flash memory cells 411˜433 are related to the threshold voltage Vt of the transistor; and, for the floating gate transistor, the threshold voltage Vt of the transistor is adjustable, therefore, in step S120 the threshold voltage Vt of the transistor is adjusted to change the weight values G₁₁˜G₃₃ stored in the flash memory cells 411˜433.

Then, in step S130, the analog voice input signal V_{A_IN} is received by the front-end device 100. Then, in step S140, analog-to-digital conversion, amplitude detection, Fast-Fourier transform and filtering are performed on the analog voice input signal V_{A_IN} by the ADC 110, the voice detector 120, the FFT converter 130 and the filter 140 of the front-end device 100 to obtain the input signal V_{F_IN}, the input signal V_{F_IN} comprises the digital input signals X_{D_1}˜X_{D_3}. Then, in step S150, digital-to-analog conversion is performed by the DAC 310-1 to 310-3 to convert the digital input signals X_{D_1} to X_{D_3} into corresponding input voltages X₁ to X₃.

Then, in step S160, the corresponding input voltages X₁˜X₃ are respectively received via the plurality of word lines WL1˜WL3 of the flash memory array. More specifically, the gate voltages V₁˜V₃ may be applied to the gate “g” of the transistor via the corresponding word lines WL1˜WL3, respectively. The gate voltages V₁˜V₃ correspond to the input voltages X₁˜X₃ received by the word lines WL1˜WL3. According to the applied gate voltages V₁-V₃, the flash memory cells 411˜433 may receive the corresponding input voltages X₁˜X₃.

Please refer to FIG. 8B, then, in step S170, an internal multiplication (i.e., an internal memory computation (IMC)) is performed by the flash memory cells 411˜433. Specifically, the flash memory cells 411˜433 themselves perform multiplications on one of the input voltages X₁˜X₃ and the weight values G11˜G33 stored in the flash memory cells 411˜433 to obtain the output currents Y₁₁˜Y₁₃. Then, in step S180, a plurality of output currents Y₁₁˜Y₁₃ of the flash memory cells 411-433 are outputted via the plurality of bit lines BL1-BL3 of the flash memory array. More specifically, the drain currents Y₁₁˜Y₁₃ may be respectively outputted from the drain “d” of the transistor via the corresponding bit lines BL1˜BL3. The drain currents I₁₁˜I₁₃ correspond to the output currents Y₁₁˜Y₁₃ output by the word lines BL1˜BL3.

Then, in step S190, the output currents of the flash memory cells connected to the same bit line among the bit lines BL1˜BL3 are accumulated as the total output currents Y_{T_1}˜Y_{T_3}. For example, the output currents Y₁₁, Y₂₁ and Y₃₁ of the flash memory cells 411, 421 and 431 connected to the same bit line BL1 are accumulated to form the total output current Y_{T_1}. In the computing method of this embodiment, the flash memory cells 411˜433 are analog components, so each of the input voltages X₁˜X₃, the output currents Y₁₁, Y₂₁, Y₃₁ and the weight values G₁₁-G₃₃ are analog values.

Then, in step S200, the input voltages X₁˜X₃ are formed into an input vector Xᵥ, the total output currents Y_{T_1}˜Y_{T_3} of the bit lines BL1˜BL3 are formed into an output vector Yᵥ, and the weight values G₁₁˜G₃₃ are formed into a weight matrix G_{M}. Accordingly, the output vector Yᵥ is the matrix product of the matrix multiplication of the input vector Xᵥ and the weight matrix G_{M}. In other words, the computing method of this embodiment may perform matrix multiplication by the memory device 400. Then, in step S210, the total output currents Y_{T_1}˜Y_{T_3} obtained by accumulations on the bit lines BL1˜BL3 respectively, are converted into digital output signals Y_{DT_1}˜Y_{DT_3} by the ADC 330-1˜330-3, and the digital output currents Y_{DT_1}˜Y_{DT_3} are outputted.

With the memory device and the computing method according to the embodiments of the present disclosure, an analog non-volatile memory device may be used to perform a matrix multiplication. Each flash memory cell of the memory device may store the weight value of the matrix multiplication, and the weight value stored in the flash memory cell may be changed by adjusting the threshold voltage of the transistor. Accordingly, the multiplication may be performed inside the memory device, and the multiplication result may be accumulated using the bit line (output line), thereby completing the entire matrix multiplication. The weight value is stored in the memory device, and the external peripheral circuit does not need to read or write the weight value, which may greatly save the amount of input/output data. The flash memory cells of an analog non-volatile memory device may be arranged in a high-density manner, thereby allowing computations with larger data volume to be performed within the same area of circuitry.

It will be apparent to those skilled in the art that various modifications and variations may be made to the disclosed embodiments. It is intended that the specification and examples be considered as exemplary only, with a true scope of the disclosure being indicated by the following claims and their equivalents.

What is claimed is:

1. A computing device, comprising:
a flash memory array, for performing a matrix multiplying-and-accumulating computation, the flash memory array comprising:
a plurality of word lines;
a plurality of bit lines; and
a plurality of flash memory cells, being arranged in an array and respectively connected to the word lines and the bit lines, for receiving a plurality of input voltages via the word lines and outputting a plurality of output currents via the bit lines, the output currents of the flash memory cells connected to the same bit line of the bit lines are accumulated to obtain a total output current,
wherein, each of the flash memory cells stores a weight value respectively, and each of the flash memory cells is operated with one of the input voltages and the weight value to obtain one of the output currents, each of the flash memory cells is an analog element, and each of the input voltages, each of the output currents and each of the weight values is an analog value.

2. The computing device of claim 1, wherein the flash memory cells operate in a triode region.

3. The computing device of claim 1, wherein each of the flash memory cells comprises a transistor, a gate of the transistor is connected to a corresponding one of the word lines to apply a gate voltage, and the gate voltage corresponds to the input voltage received by the word line, and a drain of the transistor is connected to a corresponding one of the bit lines to output a drain current, and the drain current corresponds to the output current outputted by the bit line.

4. The computing device of claim 3, wherein the transistor has an equivalent conductance value, and the equivalent conductance value corresponds to the weight value stored in the flash memory cell.

5. The computing device of claim 4, wherein the transistor has a threshold voltage, and the equivalent conductance value is related to the threshold voltage.

6. The computing device of claim 5, wherein the transistor is a floating gate transistor and the threshold voltage is adjustable, and the weight value stored in the flash memory cell changes according to the threshold voltage.

7. The computing device of claim 1, further comprising a plurality of digital-to-analog converters, respectively connected to the word lines and performing digital-to-analog conversions on a plurality of digital input signals to obtain the input voltages received by the word lines.

8. The computing device of claim 3, wherein the flash memory array further comprises:
a plurality of source lines, a source of each of the transistors is connected to a corresponding one of the source lines; and
a source switch circuit, connected to the source lines, for selecting each of the transistors.

9. The computing device of claim 1, further comprising a plurality of analog-to-digital converters, respectively connected to the bit lines, and performing analog-to-digital conversion on the total output currents accumulated by the bit lines to obtain a plurality of digital output signals.

10. An computing method, for performing a matrix multiplying-and-accumulating computation by a flash memory array, the flash memory array comprises a plurality of word lines, a plurality of bit lines and a plurality of flash memory cells, the flash memory cells are respectively connected to the word lines and the bit lines, and the computing method comprising:
respectively storing a weight value in each of the flash memory cells;
receiving a plurality of input voltages via the word lines;
performing an computation on one of the input voltages and the weight value by each of the flash memory cells to obtain an output current;
outputting the output currents of the flash memory cells via the bit lines; and
accumulating the output currents of the flash memory cells connected to the same bit line of the bit lines to obtain a total output current,
wherein, each of the flash memory cells is an analog device, and each of the input voltages, each of the output currents and each of the weight values are analog values.

11. The computing method of claim 10 further comprises:
forming an input vector with the input voltages received by the word lines;
forming an output vector with the total output currents obtained by accumulations on the bit lines; and
forming a weight matrix with the weight values stored in the flash memory cells,
wherein, the output vector is a matrix product of the input vector and the weight matrix.

12. The computing method of claim 10, wherein each of the flash memory cells comprises a transistor, a gate of the transistor is connected to a corresponding one of the word lines and a drain of the transistor is connected to a corresponding one of the bit lines, the computing method further comprises:
applying a gate voltage to the gate of the transistor via the corresponding one of the word lines, and the gate voltage corresponds to the input voltage received by the word line; and
outputting a drain current from the drain of the transistor via the corresponding one of the bit lines, and the drain current corresponds to the output current outputted by the bit line.

13. The computing method of claim 12, wherein the transistor has an equivalent conductance value, and the equivalent conductance value corresponds to the weight value stored in the flash memory cell.

14. The computing method of claim 13, wherein each of the weight values is a multi-level weight value, and the multi-level weight value has at least 4 levels.

15. The computing method of claim 14, wherein the transistor has a threshold voltage, and the equivalent conductance value is related to the threshold voltage.

16. The computing method of claim 15, wherein the transistor is a floating gate transistor and the threshold voltage is adjustable, and the computing method further comprises:
adjusting the threshold voltage to change the weight value stored in the flash memory cell.

17. The computing method of claim 13, wherein the flash memory array further comprises a plurality of source lines, and one source of each of the transistors is connected to a corresponding one of the source lines, and the computing method further comprises:
disposing a source switch circuit which is connected to the source lines; and
selecting each of the transistors by the source switch circuit.

18. The computing method of claim 11, wherein before the step of receiving the input voltages via the word lines, the computing method further comprising:
receiving a plurality of digital input signals; and
performing digital-to-analog conversions on the digital input signals to obtain the input voltages corresponding to the word lines.

19. The computing method of claim 11, wherein after the step of accumulating the output currents to obtain the total output current, the computing method further comprises:
performing analog-to-digital conversions on the total output currents to obtain a plurality of digital output signals; and
outputting the digital output signals.

20. The computing method of claim 10, wherein each of the flash memory cells comprises a transistor, a source of the transistor is connected to a corresponding one of the word lines, and a drain of the transistor is connected to a corresponding one of the bit lines, the computing method further comprises:
disposing a gate switch circuit which is connected to the gate lines;
selecting each of the transistors by the gate switch circuit;
applying a source voltage to the source of the transistor via the corresponding one of the word lines, the source voltage corresponds to the input voltage received by the word line; and
outputting a drain current from the drain of the transistor via the corresponding one of the bit lines, and the drain current corresponds to the output current outputted by the bit line.
